(19) United States
(12) Patent Application Publication
(10) Pub. No.: US 2026/0209096 A1
(43) Pub. Date: Jul. 23, 2026

(54) FILTER MODULE FOR GRAVITY-BASED WATER PURIFICATION DEVICE AND WATER PURIFICATION DEVICE COMPRISING SAME

(71) Applicant: AMOGREENTECH CO., LTD., Gimpo-si, Gyeonggi-do (KR)

(72) Inventor: Jin LEE, Gimpo-si, Gyeonggi-do (KR)

(73) Assignee: AMOGREENTECH CO., LTD., Gimpo-si, Gyeonggi-do (KR)

(21) Appl. No.: 19/143,590

(22) PCT Filed: Dec. 13, 2023
(86) PCT No.: PCT/KR2023/020562

§ 371 Date: Jun. 26, 2025

(30) Foreign Application Priority Data
Dec. 26, 2022 (KR) 10-2022-0184746

(51) Int. Cl. C02F 9/20

(52) U.S. Cl. CPC C02F 9/20; C02F 2201/002; C02F 2301/08

(57) ABSTRACT

A filter module for a gravity-based water purification device is provided. A filter module for a gravity-based water purification device, according to one embodiment of the present invention, may comprise: a filter unit including a plate-shaped filtration member having a predetermined area and including a plurality of flat filters that are arranged in parallel along one direction so that surfaces of the filtration members face each other at intervals; a filtered water collection unit that collects filtered water produced from each of the plurality of flat filters; and a case unit that is arranged so as to surround the front, rear, and upper surfaces of the filter unit with both sides of the filter unit open, includes a plurality of holes through which raw water passes such that the raw water can be smoothly supplied to the filter unit, and fixes both ends of a fastening bar that fastens the plurality of flat filters.

### CROSS REFERENCE TO THE RELATED APPLICATIONS

This application is the national phase entry of International Application No. PCT/KR 2023/020562, filed on Dec. 13, 2023, which is based upon and claims priority to Korean Patent Application No. 10-2022-0184746, filed on Dec. 26, 2022, the entire contents of which are incorporated herein by reference.

### TECHNICAL FIELD

The present invention relates to a filter module for a gravity-based water purification device and a gravity-based water purification device including the same.

### BACKGROUND

General water purifiers produce clean water by allowing water to pass through filters and removing foreign material. Such water purifiers provide a predetermined water pressure to raw water using electric energy.

Accordingly, in the conventional water purifiers, pump facilities for providing a predetermined water pressure to raw water are needed, and electricity facilities for providing electricity to the pump facilities should be provided together.

Accordingly, in poor environments where there are no facilities such as pump facilities or electrical facilities, there are limitations in producing clean water.

### SUMMARY OF THE INVENTION

The present invention has been devised in consideration of the above-described limitations and is directed to a filter module for a gravity-based water purification device which simply produces filtered water using gravity and of which maintenance is improved and a gravity-based water purification device including the same.

In order to achieve the above-described objects, the present invention provides a filter module for a gravity-based water purification device, which includes a filter assembly including a plurality of flat filters including filtration members, each of which has a plate shape having a predetermined area and of which one surfaces are arranged in parallel in one direction to be spaced an interval from and face each other, a filtered water collection assembly which collects filtered water produced by each of the plurality of flat filters, and a case assembly which is disposed to open both side surfaces of the filter assembly and surround a front surface, a rear surface, and an upper surface of the filter assembly, includes a plurality of through holes through which raw water passes to smoothly supply the raw water toward the filter assembly, and fixes both ends of a fastening bar which fastens the plurality of flat filters.

In addition, the case assembly my serves a first role of covering the filter assembly to protect the plurality of flat filters, a second role of increasing a total weight of the filter module for a gravity-based water purification device such that the filter module for a gravity-based water purification device is immersed in the raw water by the weight thereof, and a third role of allowing the filtration members to be spaced a predetermined height from a bottom surface of a storage tank in which a predetermined amount of the raw water is stored.

In addition, the case assembly may include a front plate through which a plurality of first through holes are formed to pass and which covers the front surface of the filter assembly, a rear plate through which a plurality of second through holes are formed to pass and which covers the rear surface of the filter assembly, an upper plate which connects the front plate and the rear plate and covers the upper surface of the filter assembly, and a pair of extension plates which extend from end portions of the front plate and the rear plate in one direction and are in surface contact with a bottom surface of a storage tank.

In addition, both ends of the fastening bar may each be fixed to one of the front plate and the rear plate such that the filtration members are located above the pair of extension plates in a state in which the fastening bar fastens the plurality of flat filters.

In addition, each of the flat filters may include the filtration member formed in the plate shape having the predetermined area, a support frame which is coupled to an edge of the filtration member to support the filtration member and in which a flow path along which the filtered water produced through the filtration member flows is formed, and a connecting member coupled to one side of the support frame and fastened to the fastening bar.

In addition, the connecting member may include a first portion surrounding the support frame and a second portion extending from the first portion, and the second portion may include a body which has a greater width than the first portion and in which a through hole allowing the fastening bar to pass therethrough is formed, a hollow protrusion which defines an edge of the through hole and is formed to protrude from a first surface of the body, and a hollow groove which surrounds the edge of the through hole and is formed to be recessed in a second surface opposite to the first surface of the body;

In this case, the through hole may be formed in the body to pass through both the protrusion and the groove.

Accordingly, in two flat filters disposed in parallel, the fastening bar may pass through the through hole formed in each of two flat filters, and the protrusion formed on any one of the flat filters may be fixedly inserted into the groove formed in the other flat filter.

In addition, the case assembly may be formed of a stainless material.

Meanwhile, the present invention provides a gravity-based water purification device, which includes a storage tank having an inner space in which raw water is stored and the filter module for a gravity-based water purification device disposed in the inner space to filter foreign material contained in the raw water, wherein the raw water is suctioned toward the flat filter such that the foreign material is filtered to produce filtered water.

According to the present invention, since a case assembly can prevent damage to a filtration member for producing filtered water and also prevent recontamination of the filtration member by foreign material in advance, clean filtered water can be obtained using gravity even in a poor environment in which power such as electricity is not supplied.

In addition, according to the present invention, since a filter module can be simply assembled and dissembled, the maintenance thereof can be improved.

### BRIEF DESCRIPTION OF THE DRAWINGS

FIG. 1 is a view illustrating a filter module for a gravity-based water purification device according to one embodiment of the present invention.

FIG. 2 is an exploded view of FIG. 1.

FIG. 3 is a cross-sectional view along line A-A of FIG. 1.

FIG. 4 is a cross-sectional view along line B-B of FIG. 1.

FIG. 5 is a view illustrating coupling relationships between two connecting members in the filter module for a gravity-based water purification device according to one embodiment of the present invention.

FIG. 6 is a view illustrating one example of a flat filter applicable to the filter module for a gravity-based water purification device according to one embodiment of the present invention.

FIG. 7 is an exploded view of FIG. 6.

FIG. 8 is a cross-sectional view illustrating a frame applicable to FIG. 6.

FIG. 9 is a view illustrating the connecting member applicable to FIG. 6.

FIG. 10 is a view illustrating coupling relationships between the connecting member and a support frame in FIG. 6.

FIG. 11 is a schematic view illustrating a gravity-based water purification device to which the filter module for a gravity-based water purification device is applied according to one embodiment of the present invention.

### DETAILED DESCRIPTION

Hereinafter, embodiments of the present invention will be described in detail with reference to the accompanying drawings in order for those skilled in the art to easily perform the present invention. The present invention may be implemented in several different forms and is not limited to the embodiments described herein. Parts irrelevant to description are omitted in the drawings in order to clearly describe the present invention, and the same or similar parts are denoted by the same reference numerals throughout this specification.

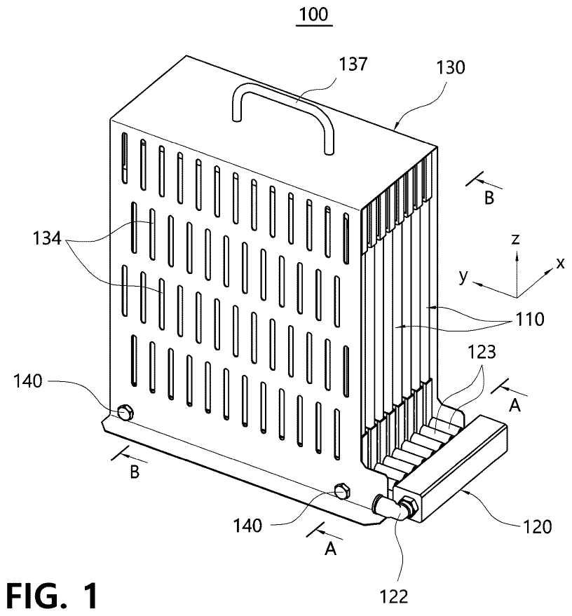

In the present specification, a front surface and a rear surface may be surfaces perpendicular to an x-axis in FIG. 1, a side surface may be a surface perpendicular to a y-axis, and an upper surface and a lower surface may be surfaces perpendicular to a z-axis. In addition, a width direction may be a direction parallel to the X-axis.

A filter module 100 for a gravity-based water purification device according to one embodiment of the present invention may be sunk in raw water and remove foreign material from the raw water using a water pressure due to gravity or potential energy to produce filtered water.

In addition, the filter module 100 for a gravity-based water purification device according to one embodiment of the present invention may be disposed in a storage tank 200 in which the raw water is stored and may be disposed in a state in which it sinks to a bottom surface of the storage tank 200 due to a weight thereof even without using a separate fixing member.

In addition, in the filter module 100 for a gravity-based water purification device according to one embodiment of the present invention, a filtration member 111 may be disposed to be spaced a predetermined distance from the bottom surface of the storage tank 200.

That is, when an amount of the raw water stored in the storage tank 200 is sufficient, the filter module 100 for a gravity-based water purification device according to one embodiment of the present invention may be disposed in the storage tank 200 and completely immersed in the raw water, and even when an amount of the raw water stored in the storage tank 200 is small, the filter module 100 for a gravity-based water purification device according to one embodiment of the present invention may maximize an amount of the raw water which comes into contact with the filtration member 111 by remaining sunk into the bottom surface of the storage tank 200.

To this end, the filter module 100 for a gravity-based water purification device according to one embodiment of the present invention includes a filter assembly, a filtered water collection assembly 120, and a case assembly 130 as illustrated in FIGS. 1 to 4.

The filter assembly may produce the filtered water by removing the foreign material from the raw water.

The filter assembly may be formed to increase a production amount of the filtered water as well as increasing a contact area with the raw water.

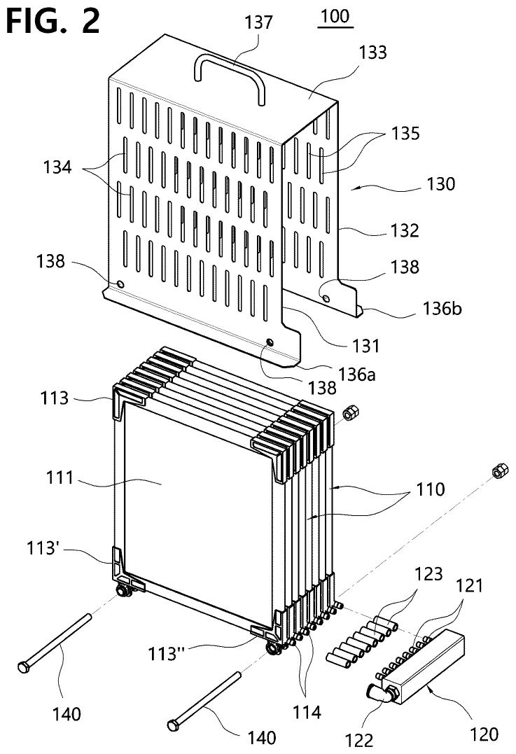

To this end, the filter assembly may include a plurality of flat filters 110 disposed in parallel in one direction as illustrated in FIG. 2, and each of the plurality of flat filters 110 may include the plate-shaped filtration member 111 having a predetermined area.

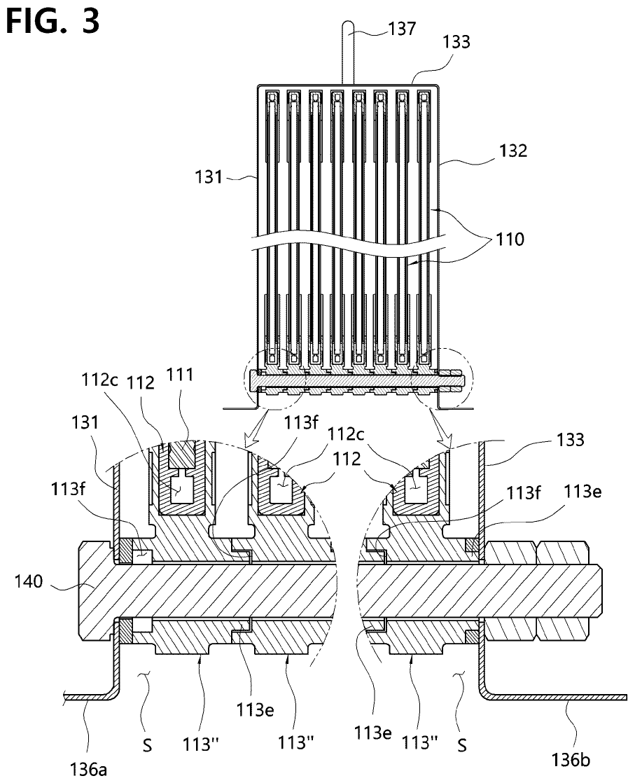

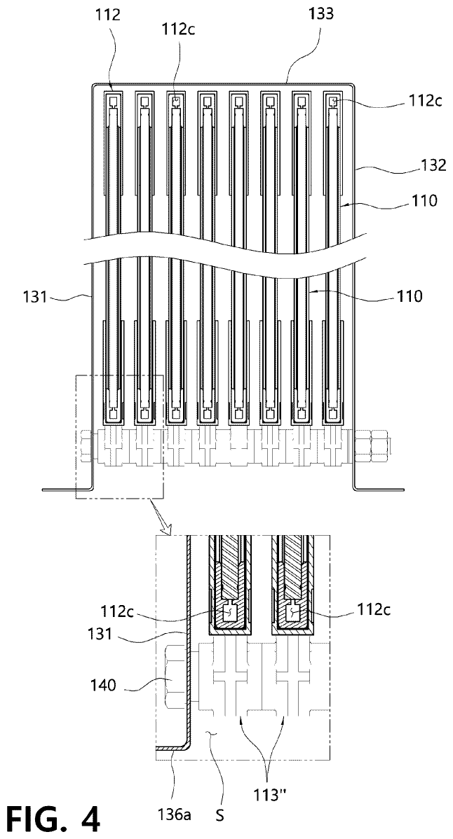

In this case, as illustrated in FIGS. 3 and 4, the plurality of flat filters 110 may be disposed in parallel in one direction such that one surfaces of the filtration members 111 are spaced an interval from and face each other, and the plurality of flat filters 110 may be integrated by fastening bars 140.

Accordingly, even when the plurality of flat filters 110 are disposed in parallel in one direction, the filtration members 111 provided in each of the flat filters 110 may smoothly come into contact with the raw water, and each of the filtration members 111 may filter the foreign material from the raw water to produce the filtered water.

Accordingly, in the filter module 100 for a gravity-based water purification device according to one embodiment of the present invention, since the plurality of flat filters 110 may produce the filtered water, a filtered water production yield can be increased.

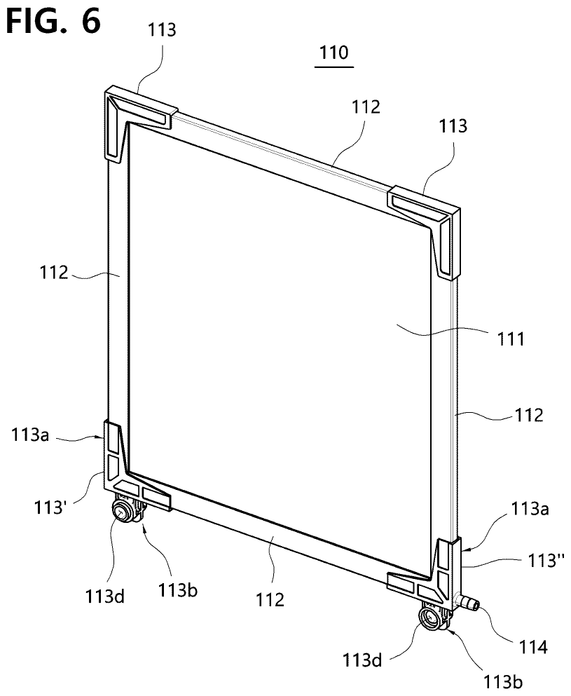

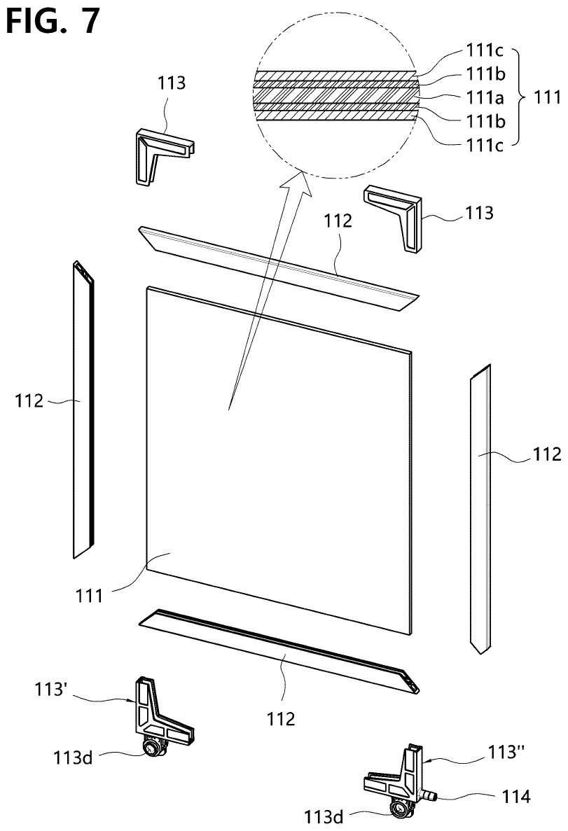

To this end, each of the plurality of flat filters 110 may include the filtration member 111 having the predetermined area and formed in the plate shape, support frames coupled to an edge of the filtration member 111 to support the filtration member 111, connecting members 113, 113′, and 113″ coupled to one sides of the support frames, and a reception port 114 for discharging the filtered water produced by the filtration member 111 to the outside as illustrated in FIGS. 6 and 7.

The filtration member 111 may filter the foreign material contained in the raw water. As illustrated in an enlarged view of FIG. 7, the filtration member 111 may include a pair of nanofiber webs 111c attached to both surfaces of a support body 111a by adhesive layers 111b.

In this case, the nanofiber webs 111c may serve to filter the foreign material contained in the raw water, and the support body 111a may serve as a passageway through which the filtered water produced by the nanofiber webs 111c passes while supporting the nanofiber webs 111c.

As an example, the support body 111a may be a porous substrate to serve as a passageway through which the filtered water produced by the nanofiber webs 111c flows. As a non-restrictive example, the support body 111a may be any one of fabric, knitted fabric, or nonwoven fabric.

In addition, the nanofiber webs 111c may be formed of nanofiber, and the nanofiber may include a fiber-forming component including polyacrylonitrile (PAN) and/or polyvinylidene fluoride (PVDF) and an emulsifying agent which improves the miscibility of the fiber-forming component.

However, the filtration member 111 is not limited thereto, and any well-known filtration member may be used as the filtration member 111 as long as the filtration member 111 is formed in a plate shape having a predetermined area and used for water treatment.

The support frame may support the edge of the filtration member 111 and allow the filtration member 111 to be maintained in the plate shape.

Although the support frame may be formed of one member and may support the edge of the filtration member 111, the support frame may include a plurality of frames 112 coupled to the edge of the filtration member 111 as illustrated in FIG. 7.

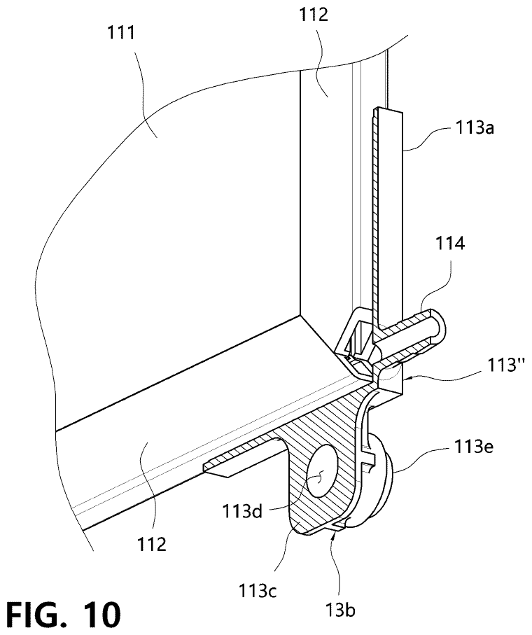

As an example, each of the plurality of frames 112 may be disposed at the edge of the filtration member 111 such that an end portion of any one is in contact with an end portion of the other, and two adjacent frames 112 may surround the edge of the filtration member 111 and may be fixed by the connecting members 113, 113′, and 113″ as illustrated in FIG. 10.

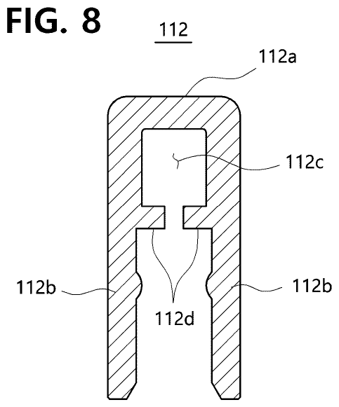

In this case, each of the frames 112 constituting the support frame may be formed in substantially a “ [symbol] ” shape of which one side is open as illustrated in FIG. 8.

Accordingly, the support frame may include a flow path 112c to allow the filtered water produced through the filtration member 111 to flow inside the support frame.

Accordingly, the support frame may serve to support the filtration member 111 and also serve as a flow passage to allow the filtered water produced by the filtration member 111 to flow toward the reception port 114.

Specifically, as illustrated in FIG. 8, each of the plurality of frames 112 may include a plate-shaped first plate 112a and a pair of second plates 112b extending predetermined lengths from both end portions of the first plate 112a, and the flow path 112c may be defined by the facing pair of second plates 112b and the first plate 112a.

In this case, restriction members 112d which restrict an insertion depth of the filtration member 111 may be formed on opposite surfaces of the facing pair of second plates 112b. Accordingly, even when the edge of the filtration member 111 is fastened to the frame 112, the insertion depth of the filtration member 111 may be restricted by the restriction members 112d, and the flow path 112c formed in the frame 112 may be maintained with a predetermined space.

The connecting members 113, 113′, and 113″ may be coupled to corners of the support frame. The connecting members 113, 113′, and 113″ may be provided as a plurality of connecting members 113, 113′, and 113″, and may be coupled to the corners of the support frame to fix end portions of the two adjacent frames 112 as described above.

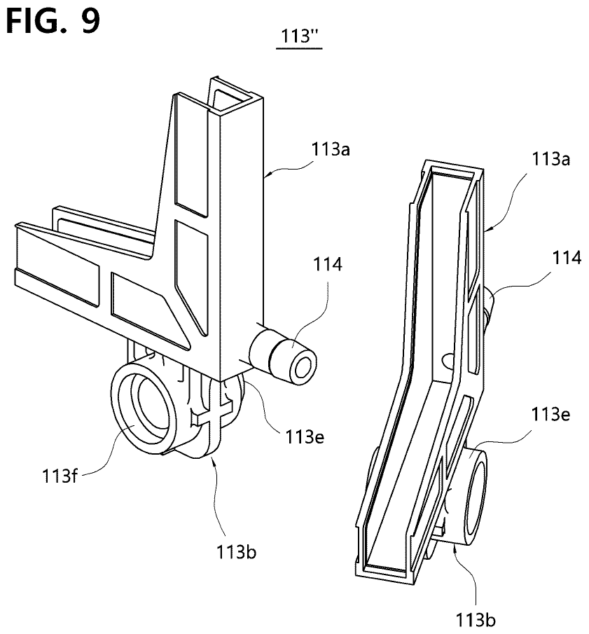

To this end, the connecting members 113, 113′, and 113″ may include first portions 113a surrounding corners of the support frame (see FIGS. 9 and 10).

In this case, among the plurality of connecting members 113, 113′, and 113″, some connecting members 113′and 113″ may serve as a fastener coupled to the fastening bars 140 while fixing end portions of the two adjacent frames 112.

To this end, as illustrated in FIGS. 9 and 10, the connecting members 113′and 113″ may include the first portions 113a surrounding the corners of the support frame and second portions 113b which extend from the first portions 113a and in which through holes 113d are formed to pass through the second portions 113b.

In this case, the first portions 113a may be formed in a shape of which one side is open to surround the support frame, and the second portions 113b may extend a predetermined length from the first portions 113a.

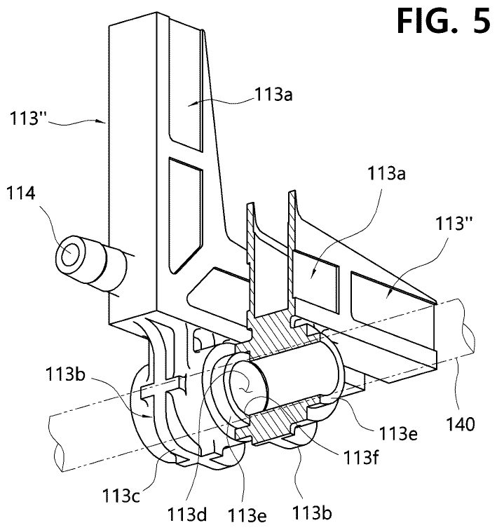

Accordingly, among the plurality of frames 112 constituting the support frame, end portions of the two adjacent frames 112 may be fixedly inserted into the first portion 113a, and the plurality of flat filters 110 arranged in parallel may be coupled to each other by the fastening bars 140 passing through the through holes 113d of the second portions 113b as illustrated in FIG. 5.

Accordingly, the plurality of flat filters 110 arranged in parallel may be integrated with each other by the fastening bars 140 passing through the through holes 113d of the second portions 113b.

In this case, the second portions 113b may serve both as fastening members to which the fastening bars 140 are fastened and distance maintaining members which maintain a distance between the filtration members 111 provided in two flat filters 110 disposed in parallel.

In addition, the second portions 113b may also serve as coupling members which couple two flat filters 110 disposed in parallel.

To this end, as illustrated in FIGS. 3 to 5, each of the second portions 113b may include a body 113c which has a greater width than the first portions 113a and in which one through hole 113d is formed to allow the fastening bar 140 to pass therethrough, a hollow protrusion 113e which defines an edge of the through hole 113d and is formed to protrude from a first surface of the body 113c, and a hollow groove 113f which surrounds the edge of the through hole 113d and is formed to be recessed in a second surface opposite to the first surface of the body.

In this case, the through hole 113d may be formed in the body 113c to pass through both the protrusion 113e and the groove 113f.

Accordingly, the fastening bar 140 may pass through both of the through holes 113d formed in two flat filters 110 disposed in parallel, and the protrusion 113e formed on any one flat filter 110 of two flat filters 110 disposed in parallel may be inserted into the groove 113f formed in the other flat filter 110.

That is, the plurality of flat filters 110 may be fixed through first coupling using the fastening bar 140 and second coupling by mutual coupling between the protrusion 113e and the groove 113f.

Accordingly, when the plurality of flat filters 110 disposed in parallel are fixed to each other by the fastening bars 140, two filtration members 111 of which one surfaces are disposed to face each other may remain to be spaced a predetermined distance by the second portions 113b even when the flat filters 110 are completely in close contact with each other.

Accordingly, since both surfaces of the filtration member 111 of each of the plurality of flat filters 110 may come into contact with the raw water, the filtered water can be produced.

In addition, when the plurality of flat filters 110 disposed in parallel are in close contact with each other, the protrusion 113e formed on any one flat filter 110 of two flat filters 110 disposed in parallel may be inserted into and coupled to the groove 113f formed in the other flat filter 110 to further increase a coupling force.

Meanwhile, at least one connecting member 113″ of the connecting members 113, 113′, and 113″ may include the reception port 114 for discharging the filtered water which flows along the flow path 112c.

As an example, the reception port 114 may be provided in the first portion 113a of the connecting member 113″ to communicate with the flow path 112c as illustrated in FIG. 10.

However, a location at which the reception port 114 is formed is not limited thereto, and the reception port 114 may be formed to be located at any of various locations according to a design condition as long as the reception port 114 communicates with the flow path 112c.

As illustrated in FIG. 2, the reception port 114 may be connected to the filtered water collection assembly 120 by a first connection tube 123. Accordingly, the filtered water produced by each of the plurality of flat filters 110 may flow to the filtered water collection assembly 120 through the reception port 114.

The filtered water collection assembly 120 may collect the filtered water produced by each of the flat filters 110. That is, the filtered water collection assembly 120 may be connected to the reception port 114 formed in each of the plurality of flat filters 110.

Accordingly, the filtered water collection assembly 120 may collect the filtered water individually produced by each of the flat filters 110 in one space.

To this end, as illustrated in FIG. 1, the filtered water collection assembly 120 may include a plurality of inlet ports 121 connected one-to-one to the reception ports 114 by first connection tubes 123 and a discharge port 122 for discharging the filtered water introduced through the plurality of inlet ports 121 to the outside.

Accordingly, the filtered water individually produced by each of the plurality of flat filters 110 may be collected by the filtered water collection assembly 120 and then discharged through the discharge port 122.

The case assembly 130 may allow the raw water for producing the filtered water to be smoothly introduced toward the filter assembly and also protect the filter assembly to prevent the filtration member 111 of the flat filter 110 from being damaged.

In addition, the case assembly 130 may fix both end portions of the fastening bars 140 which fasten the plurality of flat filters 110. That is, both end portions of the fastening bars 140 may be fixed to fastening holes 138 formed in the case assembly 130 in a state in which the fastening bars 140 fasten the plurality of flat filters 110 disposed in parallel.

Accordingly, the plurality of flat filters 110 may be fixed to the case assembly 130 by the fastening bars 140 and integrated with the case assembly 130 by the fastening bars 140 when both end portions of the fastening bars 140 are fixed to the case assembly 130.

Accordingly, when the fastening bars 140 are separated from the case assembly 130, a worker may selectively replace any one of the plurality of flat filters 110.

Accordingly, although the filter module 100 for a gravity-based water purification device according to one embodiment of the present invention includes the plurality of flat filters 110 disposed in parallel, since the filter module 100 may be simply assembled and dissembled using the fastening bars 140, the maintenance of the filter module 100 can be improved.

In this case, the case assembly 130 may include a handle 137 such that the worker can easily perform attachment.

Accordingly, the worker may simply move the filter module 100 for a gravity-based water purification device according to one embodiment of the present invention using the handle 137 in a state in which the plurality of flat filters 110 and the case assembly 130 are coupled to each other by the fastening bars 140.

To this end, the case assembly 130 may be disposed to open both side surfaces of the filter assembly and surround a front surface, a rear surface, and an upper surface of the filter assembly, may include a plurality of through holes 134 and 135 through which the raw water passes such that the raw water is smoothly supplied toward the filter assembly, and may fix both ends of the fastening bars 140 which fasten the plurality of flat filters 110.

As an example, the case assembly 130 may include a front plate 131 in which a plurality of first through holes 134 are formed to pass through the front plate 131 and which covers the front surface of the filter assembly, a rear plate 132 in which a plurality of second through holes 135 are formed to pass through the rear plate 132 and which covers the rear surface of the filter assembly, and an upper plate 133 which connects the front plate 131 and the rear plate 132 and covers the upper surface of the filter assembly as illustrated in FIGS. 1 and 2.

Accordingly, the case assembly 130 may be disposed to surround the front surface, the rear surface, and the upper surface of the filter assembly to protect the filter assembly, and the raw water may smoothly flow toward the filter assembly from the outside of the case assembly 130 through both open side surfaces of the filter assembly and the first through holes 134 and the second through holes 135.

In this case, the case assembly 130 may be formed of a metal material of which a specific gravity is greater than that of water.

As an example, the case assembly 130 may be formed of a stainless material.

Accordingly, the case assembly 130 may increase the total weight of the filter module 100 for a gravity-based water purification device according to one embodiment of the present invention.

That is, since the total weight of the filter module 100 for a gravity-based water purification device according to the present invention increases due to the case assembly 130, the filter module 100 may be sunk into the bottom surface of the storage tank 200 filled with the raw water even without using a separate restriction member.

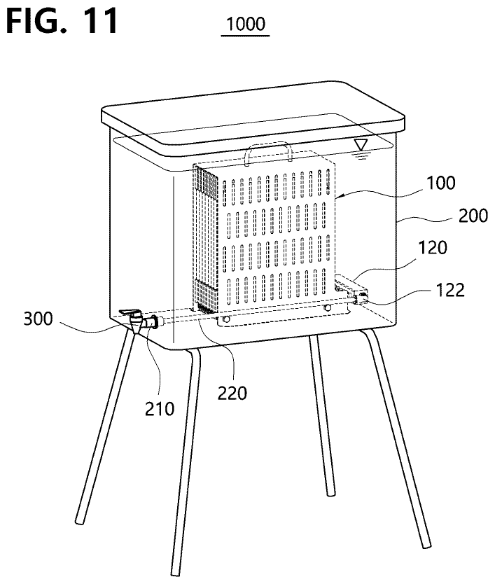

Accordingly, as illustrated in FIG. 11, when an amount of the raw water stored in the storage tank 200 is sufficient, the filter module 100 for a gravity-based water purification device according to one embodiment of the present invention may be disposed in the storage tank 200 and completely immersed in the raw water, and even when an amount of the raw water stored in the storage tank 200 is small, a state in which the filter module 100 for a gravity-based water purification device according to one embodiment of the present invention is sunk into the bottom surface of the storage tank 200 is maintained to maximize an amount of the raw water which comes into contact with the filtration members 111.

Accordingly, the case assembly 130 may serve both a first role of covering the filter assembly to protect the plurality of flat filters 110 and a second role of increasing the total weight of the filter module 100 for a gravity-based water purification device such that the filter module 100 for a gravity-based water purification device is smoothly immersed in the raw water by the weight thereof.

In this case, the case assembly 130 may include a pair of extension plates 136a and 136b extending from end portions of the front plate 131 and the rear plate 132 in one direction.

As an example, the pair of extension plates 136a and 136b may extend in directions perpendicular to the front plate 131 and the rear plate 132. As a non-restrictive example, when the filter module 100 for a gravity-based water purification device according to one embodiment of the present invention is disposed on the bottom surface of the storage tank 200, the pair of extension plates 136a and 136b may extend in a direction parallel to the bottom surface of the storage tank 200.

Accordingly, when the filter module 100 for a gravity-based water purification device according to one embodiment of the present invention is sunk into the bottom surface of the storage tank 200 due to the case assembly 130, the filter module 100 for a gravity-based water purification device may maintain a state of stably standing upright on the bottom surface of the storage tank 200 using the pair of extension plates 136a and 136b as illustrated in FIG. 11.

In this case, the first through holes 134 and the second through holes 135 respectively formed in the front plate 131 and the rear plate 132 may be formed as long holes having predetermined lengths to be long in a direction parallel to a height direction of the front plate 131 and the rear plate 132 and minimize buoyancy when the filter module 100 is immersed.

Meanwhile, as illustrated in FIGS. 3 and 4, both ends of the fastening bars 140 may be fixed to the front plate 131 and the rear plate 132 such that a lower end of the flat filter 110 is located above the pair of extension plates 136a and 136b in a state in which the fastening bars 140 fasten the plurality of flat filters 110.

Accordingly, when the filter module 100 for a gravity-based water purification device according to one embodiment of the present invention is installed on the bottom surface of the storage tank 200, the lower ends of the flat filters 110 constituting the filter assembly may be disposed to be spaced a predetermined height from the bottom surface of the storage tank 200.

In other words, when an amount of the raw water stored in the storage tank 200 is a predetermined amount or more, the filter module 100 may remain completely immersed in the raw water, and as illustrated in FIG. 4, the filtration member 111 in each of the flat filters 110 may remain to be spaced a predetermined height from the bottom surface of the storage tank 200.

To this end, the fastening holes 138 may be formed in the front plate 131 and the rear plate 132 respectively to be spaced a predetermined height from the pair of extension plates 136a and 136b.

Accordingly, when the plurality of flat filters 110 integrated by the fastening bars 140 are coupled to the case assembly 130, the plurality of flat filters 110 may remain to be spaced a predetermined height from the pair of extension plates 136a and 136b.

Accordingly, in each of the flat filters 110, the filtration member 111 may always remain to be spaced the predetermined height from the bottom surface of the storage tank 200.

Accordingly, a deposition space S in which the foreign material is deposited may be formed between the filter assembly and the pair of extension plates 136a and 136b, and the foreign material separated from the raw water in a process of producing the filtered water from the raw water may be deposited in the foreign material deposition space S.

Accordingly, in the filter module 100 for a gravity-based water purification device according to one embodiment of the present invention, since the foreign material deposition space S may be formed between the filter assembly and the pair of extension plates 136a and 136b, the foreign material separated from the raw water in the process of producing the filtered water through the filtration members 111 may be deposited in the foreign material deposition space S.

Accordingly, since a possibility of the filtration member 111 coming into contact with the foreign material separated from the raw water and deposited in the foreign material deposition space S is fundamentally prevented, contamination due to the foreign material separated from the raw water can be prevented.

Accordingly, since the filter module 100 for a gravity-based water purification device according to one embodiment of the present invention may minimize contact between the foreign material separated from the raw water and the filtration member 111 for producing the filtered water from the raw water, maintenance can be easily performed by reducing a washing cycle of the filtration member 111, and stability of water quality can be secured.

As described above, in the filter module 100 for a gravity-based water purification device according to one embodiment of the present invention, the case assembly 130 may serve all of the first role of covering the filter assembly to protect the plurality of flat filters 110, the second role of increasing the total weight of the filter module 100 for a gravity-based water purification device such that the filter module 100 for a gravity-based water purification device is smoothly immersed in the raw water by the weight thereof, and a third role of allowing the filtration member 111 to be spaced the predetermined height from the bottom surface of the storage tank 200 in which a predetermined amount of the raw water is stored.

Meanwhile, the filter module 100 for a gravity-based water purification device may be implemented into a gravity-based water purification device 1000 which produces filtered water using gravity.

As an example, the gravity-based water purification device 1000 according to one embodiment of the present invention may include the storage tank 200 and the filter module 100 as illustrated in FIG. 11.

The storage tank 200 may store a predetermined amount of raw water which is a treatment target liquid, and the filter module 100 for producing the filtered water from the raw water may be disposed in the storage tank 200. To this end, the storage tank 200 may be formed in a box shape having a predetermined inner space.

Herein, the filter module 100 may be the filter module 100 for a gravity-based water purification device described above, and the filter module 100 may be disposed in the inner space to be located on the bottom surface of the storage tank 200.

That is, the filter module 100 may be disposed in the inner space such that the pair of extension plates 136a and 136b are in contact with the bottom surface of the storage tank 200.

In this case, a filtered water discharge port 210 connected to the filter module 100 disposed in the inner space may be provided at one side of the storage tank 200, and a known opening and closing valve 300 may be installed at the filtered water discharge port 210.

As an example, the filtered water discharge port 210 may be connected to the discharge port 122 of the filtered water collection assembly 120 by a second connection tube 220.

Accordingly, the filtered water produced by the filter module 100 may flow to the filtered water discharge port 210 through the filtered water collection assembly 120 and the second connection tube 220.

Accordingly, when the opening and closing valve 300 is manipulated to open the filtered water discharge port 210, a water pressure due to gravity and potential energy may be generated in the inner space while the filtered water produced by the filter module 100 is discharged through the filtered water discharge port 210.

Accordingly, the raw water stored in the inner space may penetrate the filtration member 111 of the filter module 100 due to the water pressure, foreign material may be filtered, the raw water may be changed to the filtered water, and the filtered water produced by the filter module 100 may flow toward the filtered water discharge port 210.

As described above, the gravity-based water purification device 1000 according to one embodiment of the present invention may produce the filtered water from the raw water using the water pressure due to gravity and potential energy. Accordingly, since the gravity-based water purification device 1000 according to one embodiment of the present invention may produce the filtered water even without using additional power such as electricity, the gravity-based water purification device 1000 can simply produce required filtered water even in a poor environment in which an infrastructure such as electricity is not installed or electricity supply is difficult.

While embodiments of the present invention have been described above, the spirit of the present invention is not limited to the embodiments proposed in this specification, and other embodiments may be easily suggested by adding, changing, and removing components within the range of the same spirit by those skilled in the art and will fall within the spiritual range of the present invention.

What is claimed is:

1. A filter module for a gravity-based water purification device, the filter module comprising:
a filter assembly including a plurality of flat filters including filtration members, each of which has a plate shape having a predetermined area and of which one surfaces are arranged in parallel in one direction to be spaced an interval from and face each other;
a filtered water collection assembly which collects filtered water produced by each of the plurality of flat filters; and
a case assembly which is disposed to open both side surfaces of the filter assembly and surround a front surface, a rear surface, and an upper surface of the filter assembly, includes a plurality of through holes through which raw water passes to smoothly supply the raw water toward the filter assembly, and fixes both ends of a fastening bar which fastens the plurality of flat filters.

2. The filter module of claim 1, wherein the case assembly serves:
a first role of covering the filter assembly to protect the plurality of flat filters;
a second role of increasing a total weight of the filter module for a gravity-based water purification device such that the filter module for a gravity-based water purification device is immersed in the raw water by the weight thereof; and
a third role of allowing the filtration members to be spaced a predetermined height from a bottom surface of a storage tank in which a predetermined amount of the raw water is stored.

3. The filter module of claim 1, wherein the case assembly includes:
a front plate through which a plurality of first through holes are formed to pass and which covers the front surface of the filter assembly;
a rear plate through which a plurality of second through holes are formed to pass and which covers the rear surface of the filter assembly;
an upper plate which connects the front plate and the rear plate and covers the upper surface of the filter assembly; and
a pair of extension plates which extend from end portions of the front plate and the rear plate in one direction and are in surface contact with a bottom surface of a storage tank.

4. The filter module of claim 3, wherein both ends of the fastening bar is each fixed to one of the front plate and the rear plate such that the filtration members are located above the pair of extension plates in a state in which the fastening bar fastens the plurality of flat filters.

5. The filter module of claim 1, wherein each of the flat filters includes:
the filtration member formed in the plate shape having the predetermined area;
a support frame which is coupled to an edge of the filtration member to support the filtration member and in which a flow path along which the filtered water produced through the filtration member flows is formed; and
a connecting member coupled to one side of the support frame and fastened to the fastening bar.

6. The filter module of claim 5, wherein:
the connecting member includes a first portion surrounding the support frame and a second portion extending from the first portion;
the second portion includes a body which has a greater width than the first portion and in which a through hole allowing the fastening bar to pass therethrough is formed, a hollow protrusion which defines an edge of the through hole and is formed to protrude from a first surface of the body, and a hollow groove which surrounds the edge of the through hole and is formed to be recessed in a second surface opposite to the first surface of the body;
the through hole is formed in the body to pass through both the protrusion and the groove; and
in two flat filters disposed in parallel, the fastening bar passes through the through hole formed in each of two flat filters, and the protrusion formed on any one of the flat filters is fixedly inserted into the groove formed in the other flat filter.

7. The filter module of claim 1, wherein the case assembly is formed of a stainless material.

8. A gravity-based water purification device comprising:
a storage tank having an inner space in which raw water is stored; and
a filter module for a gravity-based water purification device disposed in the inner space to filter foreign material contained in the raw water, wherein the raw water is suctioned toward the flat filter such that the foreign material is filtered to produce filtered water;
wherein the filter module comprises:
a filter assembly comprising a plurality of flat filters comprising filtration members, each of which has a plate shape having a predetermined area and of which one surfaces are arranged in parallel in one direction to be spaced an interval from and face each other;
a filtered water collection assembly which collects filtered water produced by each of the plurality of flat filters; and
a case assembly which is disposed to open both side surfaces of the filter assembly and surround a front surface, a rear surface, and an upper surface of the filter assembly, includes a plurality of through holes through which raw water passes to smoothly supply the raw water toward the filter assembly, and fixes both ends of a fastening bar which fastens the plurality of flat filters.

9. The gravity-based water purification device of claim 8, wherein the case assembly serves:
a first role of covering the filter assembly to protect the plurality of flat filters;
a second role of increasing a total weight of the filter module for a gravity-based water purification device such that the filter module for a gravity-based water purification device is immersed in the raw water by the weight thereof; and
a third role of allowing the filtration members to be spaced a predetermined height from a bottom surface of a storage tank in which a predetermined amount of the raw water is stored.

10. The gravity-based water purification device of claim 8, wherein the case assembly includes:
a front plate through which a plurality of first through holes are formed to pass and which covers the front surface of the filter assembly;
a rear plate through which a plurality of second through holes are formed to pass and which covers the rear surface of the filter assembly;
an upper plate which connects the front plate and the rear plate and covers the upper surface of the filter assembly; and
a pair of extension plates which extend from end portions of the front plate and the rear plate in one direction and are in surface contact with a bottom surface of a storage tank.

11. The gravity-based water purification device of claim 10, wherein both ends of the fastening bar is each fixed to one of the front plate and the rear plate such that the filtration members are located above the pair of extension plates in a state in which the fastening bar fastens the plurality of flat filters.

12. The gravity-based water purification device of claim 8, wherein each of the flat filters includes:
the filtration member formed in the plate shape having the predetermined area;
a support frame which is coupled to an edge of the filtration member to support the filtration member and in which a flow path along which the filtered water produced through the filtration member flows is formed; and
a connecting member coupled to one side of the support frame and fastened to the fastening bar.

13. The gravity-based water purification device of claim 12, wherein:
the connecting member includes a first portion surrounding the support frame and a second portion extending from the first portion;
the second portion includes a body which has a greater width than the first portion and in which a through hole allowing the fastening bar to pass therethrough is formed, a hollow protrusion which defines an edge of the through hole and is formed to protrude from a first surface of the body, and a hollow groove which surrounds the edge of the through hole and is formed to be recessed in a second surface opposite to the first surface of the body;
the through hole is formed in the body to pass through both the protrusion and the groove; and
in two flat filters disposed in parallel, the fastening bar passes through the through hole formed in each of two flat filters, and the protrusion formed on any one of the flat filters is fixedly inserted into the groove formed in the other flat filter.

14. The gravity-based water purification device of claim 8, wherein the case assembly is formed of a stainless material.
